(19) United States
(12) Patent Application Publication
(10) Pub. No.: US 2013/0128741 A1
(43) Pub. Date: May 23, 2013

(54) FLOW BASED QOS ROUTER CAPABLE OF REPORTING REAL-TIME STATISTICS

(71) Applicant: Electronics and Telecommunications Research In, Daejeon (KR)

(72) Inventors: Sang Jin HONG, Gyeonggi-do (KR); Sung Back HONG, Daejeon (KR); Jung Sik KIM, Daejeon (KR); Seong MOON, Daejeon (KR); Pyung-Koo PARK, Daejeon (KR); Ho Sun YOON, Daejeon (KR); Ho Yong RYU, Daejeon (KR); Sun Cheul KIM, Daejeon (KR); Seung Woo HONG, Daejeon (KR); Young Soo SHIN, Daejeon (KR); Soon Seok LEE, Daejeon (KR)

(73) Assignee: Electronics and Telecommunications Research Institute, Daejeon (KR)

(21) Appl. No.: 13/684,315

(22) Filed: Nov. 23, 2012

(30) Foreign Application Priority Data
Nov. 23, 2011 (KR) 10-2011-0123081

(51) Int. Cl. H04L 12/56

(52) U.S. Cl. CPC H04L 47/24
USPC 370/235

(57) ABSTRACT

Disclosed is a flow-based QoS router capable of reporting real-time statistics, including: a line card configured to collect flow information by analyzing a flow, classify the collected flow information into flow information not requesting filtering and flow information requesting filtering, and transmit each of the flow information not requesting filtering and the flow information requesting filtering; a system supervisor controller configured to receive the flow information not requesting filtering and the flow information requesting filtering from the line card and store the flow information not requesting filtering and the flow information requesting filtering, and accessed by a manager terminal to monitor the flow information not requesting filtering and the flow information requesting filtering to perform filtering of and QoS application to a predetermined flow; and an application processor configured to command QoS application to the predetermined flow according to a request from the system supervisor controller.

### CROSS-REFERENCE TO RELATED APPLICATIONS

This application is based on and claims priority from Korean Patent Application No. 10-2011-0123081, filed on Nov. 23, 2011, with the Korean Intellectual Property Office, the disclosure of which is incorporated herein in its entirety by reference.

### TECHNICAL FIELD

The present disclosure relates to a flow-based QoS router, and more particularly, to a flow-based QoS router capable of reporting real-time statistics that can increase convenience of operating a network by performing a statistics reporting function in real time therein.

### BACKGROUND

A current flow-based QoS router serves to provide periodically simplified flow information (aggregated flow report) or just dump unprocessed flow information (raw flow report).

However, the simplified flow information is not suitable for measuring a real-time quality guarantee service such as VoIP or VOD and the unprocessed flow information may require a large capacity of external server or exert a bad influence on the performance of the router thereof, because the unprocessed flow information has a too large amount of data.

Since the existing flow-based QoS router transmits collected statistics information to an external server, which needs to be analyzed for statistics reporting, the existing flow-based QoS router is difficult to monitor the information in real time, and requires a method capable of monitoring and managing the information in real time by using a memory DB in the router due to a problem in session control.

### SUMMARY

The present disclosure has been made in an effort to provide a flow-based QoS router capable of reporting real-time statistics that can perform a real-time statistics reporting function with a large amount of data by constructing a memory DB capable of supporting high-speed input/output as an application service therein, and monitor abnormal traffic and reflect a QoS policy to predetermined traffic.

An exemplary embodiment of the present disclosure provides a flow-based QoS router capable of reporting real-time statistics, including: a line card configured to collect flow information by analyzing a flow, classify the collected flow information into flow information not requesting filtering and flow information requesting filtering, and transmit each of the flow information not requesting filtering and the flow information requesting filtering; a system supervisor controller configured to receive the flow information not requesting filtering and the flow information requesting filtering from the line card and store the flow information not requesting filtering and the flow information requesting filtering, and accessed by a manager terminal to monitor the flow information not requesting filtering and the flow information requesting filtering to perform filtering of and QoS application to a predetermined flow; and an application processor configured to command QoS application to the predetermined flow according to a request from the system supervisor controller.

As described above, according to the exemplary embodiments of the present disclosure, it is possible to increase management convenience of a network operator by providing the flow-based QoS router capable of reporting real-time statistics.

By providing the flow-based QoS router capable of filtering the flow information for each source address, each destination address, and each source address & destination address, a user can perform an appropriate QoS policy, thereby improving the quality of traffic.

By providing the flow-based QoS router including the memory DB capable of supporting high-speed input/output, it is possible to easily achieve statistics reporting of a large amount of data.

By providing the flow-based QoS router including a web server which can be accessed by a manager terminal, a manager can monitor statistics information in real time.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block configuration diagram illustrating a schematic configuration of a flow-based QoS router capable of reporting real-time statistics according to an exemplary embodiment of the present disclosure.

FIG. 2 is a diagram illustrating a table list of a statistics collection table according to the exemplary embodiment of the present disclosure.

FIG. 3 is a diagram illustrating a table list of a memory DB according to the exemplary embodiment of the present disclosure.

FIG. 4 is a flowchart for describing an operation of a flow-based QoS router capable of reporting real-time statistics according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

In a flow-based QoS router according to the present disclosure, packets of the same type are defined as one flow and a QoS guarantee policy or a network management policy is applied for each defined flow to satisfy service quality and security requests due to recent network extension.

FIG. 1 is a block configuration diagram illustrating a schematic configuration of a flow-based QoS router capable of reporting real-time statistics according to an exemplary embodiment of the present disclosure.

Referring to FIG. 1, the flow-based QoS router according to the present disclosure includes a line card (hereinafter, referred to as ‘LC’) including a process array (hereinafter, referred to as ‘PA’) 110, a direct memory access (hereinafter, referred to as ‘DMA’) 120 and a slow path processor (hereinafter, referred to as ‘SPP’) 130, a system supervisor controller (hereinafter, referred to as ‘SSC’) including a DB interface 140, a memory DB 150 and a web server 160 and an application processor (hereinafter, referred to as ‘AP’) including a QoS applied server 170. Herein, the SSP 130 includes a statistics report server 132, a statistics collection table 134 and a filtering table 136.

The LC collects flow information by analyzing a flow, classifies the collected flow information into flow information not requesting filtering and flow information requesting filtering, and transmits each of the flow information not requesting filtering and the flow information requesting filtering to the SSC.

The SSC receives the flow information not requesting filtering and the flow information requesting filtering from the LC and stores the flow information not requesting filtering and the flow information requesting filtering. A manager terminal 100 monitors the flow information not requesting filtering and the flow information requesting filtering by accessing the SSC to perform filtering and QoS application to a predetermined flow.

The AP commands QoS application to the predetermined flow according to a request from the SSC.

Hereinafter, functions of the components constituting each of the LC, the SSC and the AP will be described in detail.

The PA 110 as the process in the LC performs a packet classifying operation by block-searching the flow, and collects the flow information by dropping, writing or sampling packets. The PA 110 performs filtering of a predetermined flow according to a command from the web server 160 and performs QoS application to the predetermined flow according to a command from the QoS applied server 170.

The DMA 120 accumulates the flow information in a buffer according to a processing result of the PA 110.

The SPP 130 classifies the flow information accumulated in the DMA 120 into the flow information not requesting filtering and the flow information requesting filtering, temporarily stores the flow information not requesting filtering and the flow information requesting filtering, and transmits each of the flow information not requesting filtering and the flow information requesting filtering to the DB interface 140 to be described below.

To this end, the SSP 130 includes the statistics report server 132, the statistics collection table 134 and the filtering table 136.

The statistics report server 132 classifies the flow information accumulated in the DMA 120 into the flow information not requesting filtering and the flow information requesting filtering.

The statistics collection table 134 arranges the flow information not requesting filtering for each source address (hereinafter, referred to as ‘SA’), each destination address (hereinafter, referred to as ‘DA’), each source address & destination address (hereinafter, referred to as ‘SA & DA’) and each application identification (ID) and stores the arranged flow information in a statistics data format, and transmits the flow information not requesting filtering to the DB interface 140 every three minutes.

The filtering table 136 stores the flow information requesting filtering in a raw data format and transmits the flow information requesting filtering to the DB interface 140 every second.

The DB interface 140 transfers the flow information not requesting filtering received from the statistics collection table 134 and the flow information requesting received from the filtering table 136 to the memory DB 150.

The memory DB 150 arranges the flow information not requesting filtering in the order of count and byte to generate and store top N information and arranges the flow information requesting filtering for each SA, each DA, each SA & DA and each application ID to generate and store statistics information.

The web server 160 is a server which is accessed by the manager terminal 100 to monitor the flow information and control the flow. Accordingly, the manager terminal 100 accesses the web server 160 through manager authentication to monitor a state of the router, the top N information and the statistics information and perform filtering of and QoS application to predetermined traffic. In this case, the manager terminal 100 may perform filtering of the predetermined flow simultaneously in the SA, the DA and the SA & DA.

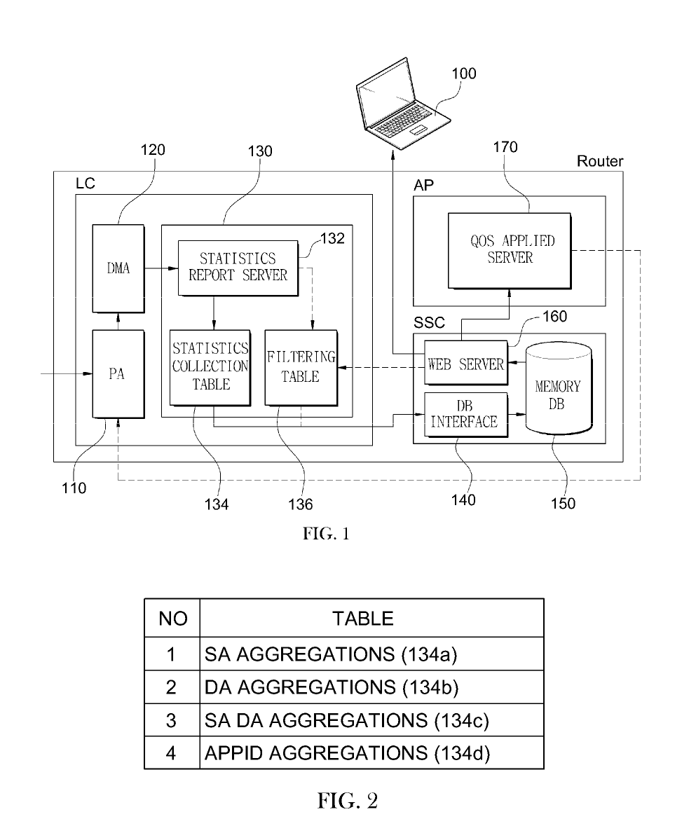

FIG. 2 is a diagram illustrating a table list of a statistics collection table according to the exemplary embodiment of the present disclosure.

Referring to FIG. 2, the statistics collection table 134 includes an SA aggregation table 134a, a DA aggregation table 134b, an SA & DA aggregation table 134c and an application ID aggregation table 134d.

The SA aggregation table 134a stores the flow information not requesting filtering for each SA.

The DA aggregation table 134b stores the flow information not requesting filtering for each DA.

The SA & DA aggregation table 134c stores the flow information not requesting filtering for each SA & DA.

The application ID aggregation table 134d stores the flow information not requesting filtering for each application ID.

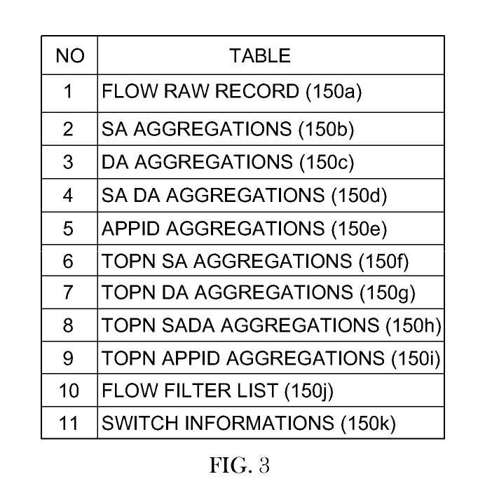

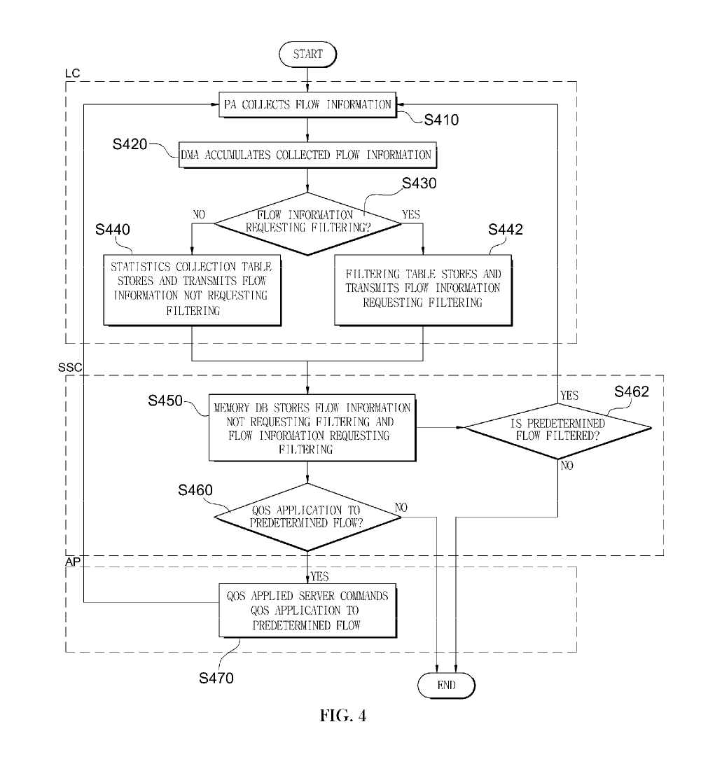

FIG. 3 is a diagram illustrating a table list of a memory DB according to the exemplary embodiment of the present disclosure.

Referring to FIG. 3, the memory DB 150 includes a flow raw record table 150a, a SA aggregation table 150b, a DA aggregation table 150c, a SA & DA aggregation table 150d, an application ID aggregation table 150e, a top N SA aggregation table 150f, a top N DA aggregation table 150g, a top N SA & DA aggregation table 150h, a top N application ID aggregation table 150i, a flow filter list table 150j, and a switch information table 150k.

The flow raw record table 150a stores the flow information requesting filtering so as for the manager to process the flow information requesting filtering in real time.

The SA aggregation table 150b analyzes the flow information requesting filtering stored in the flow raw record table 150a in real time to store the flow information by using the SA as a primary key when the corresponding flow information is flow information which did not exist in the related art and update the existing SA when the corresponding flow information is the existing flow information.

The DA aggregation table 150c analyzes the flow information requesting filtering stored in the flow raw record table 150a in real time to store the flow information by using the DA as a primary key when the corresponding flow information is flow information which did not exist in the related art and update the existing DA when the corresponding flow information is the existing flow information.

The SA & DA aggregation table 150d analyzes the flow information requesting filtering stored in the flow raw record table 150a in real time to store the flow information by using the SA & DA as a primary key when the corresponding flow information is flow information which did not exist in the related art and update the existing SA & DA when the corresponding flow information is the existing flow information.

The application ID aggregation table 150e analyzes the flow information requesting filtering stored in the flow raw record table 150a in real time to store the flow information by using the application ID as a primary key when the corresponding flow information is flow information which did not exist in the related art and update the existing application ID when the corresponding flow information is the existing flow information.

The top N SA aggregation table 150f arranges and stores the flow information not requesting filtering in the order of count or byte with respect to the SA.

The top N DA aggregation table 150g arranges and stores the flow information not requesting filtering in the order of count or byte with respect to the DA.

The top N SA & DA aggregation table 150h arranges and stores the flow information not requesting filtering in the order of count or byte with respect to the SA & DA.

The top N application ID aggregation table 150i arranges and stores the flow information not requesting filtering in the order of count or byte with respect to the application ID.

The flow filter list table 150j manages a flow which the manager intends to filter.

The switch information table 150k stores switch information of the flow-based QoS router.

FIG. 4 is a flowchart for describing an operation of a flow-based QoS router capable of reporting real-time statistics according to an exemplary embodiment of the present disclosure.

Referring to FIG. 4, the PA 110 performs a packet classifying operation by block-searching the flow, and collects the flow information by dropping, writing or sampling packets (S410). In this case, the PA 110 may perform filtering of a predetermined flow according to a command from the web server 160 or perform QoS application to the predetermined flow according to a command from the QoS applied server 170.

The DMA 120 accumulates the flow information in a buffer according to a processing result of the PA 110 (S420).

The statistics report server 132 judges whether the flow information accumulated in the DMA 120 is the flow information requesting filtering to classify the flow information into the flow information not requesting filtering and the flow information requesting filtering (S430).

The statistics collection table 134 arranges the flow information not requesting filtering for each SA, each DA, each SA & DA and each application ID and stores the arranged flow information in a statistics data format, and transmits the flow information not requesting filtering to the memory DB 150 every three minutes (S440).

The filtering table 136 stores the flow information requesting filtering in a raw data format and transmits the flow information requesting filtering to the memory DB 150 every second (S442).

The memory DB 150 arranges the flow information not requesting filtering in the order of count and byte to generate and store top N information and arranges the flow information requesting filtering for each SA, each DA, each SA and DA and each application ID to generate and store statistics information (S450).

The manager terminal 100 accesses the web server 160 through manager authentication. As a result, the web server 160 judges whether or not to receive a request for QoS application to the predetermined flow from the manager terminal 100 (S460).

When the request for QoS application to the predetermined flow is received from the manager terminal 100, the QoS applied server 170 commands QoS application to the PA 110 according to the QoS application request of the web server 160 (S470). As a result, the PA 110 performs QoS application to the predetermined flow.

The web server 160 judges whether or not to receive a request for filtering the predetermined flow from the manager terminal (S462) and when the web server 160 receives the request for filtering the predetermined flow from the manager terminal 100, the web server 160 commands the PA 110 to filter the predetermined flow. As a result, the PA 110 performs filtering of the predetermined flow.

Accordingly, the flow-based QoS router according to the present disclosure analyzes the flow information by using its own internal memory DB instead of an existing method of analyzing the flow information by transmitting the flow information defined in own interior to an external server, thereby reducing a burden caused by external transmission and improving statistics reporting efficiency.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A flow-based QoS router capable of reporting real-time statistics, comprising:
a line card configured to collect flow information by analyzing a flow, classify the collected flow information into flow information not requesting filtering and flow information requesting filtering, and transmit each of the flow information not requesting filtering and the flow information requesting filtering;
a system supervisor controller configured to receive the flow information not requesting filtering and the flow information requesting filtering from the line card and store the flow information not requesting filtering and the flow information requesting filtering, and accessed by a manager terminal to monitor the flow information not requesting filtering and the flow information requesting filtering to perform filtering of and QoS application to a predetermined flow; and
an application processor configured to command QoS application to the predetermined flow according to a request from the system supervisor controller.

2. The flow-based QoS router capable of reporting real-time statistics of claim 1, wherein the line card includes,
a process array configured to collect the flow information by analyzing the flow and perform filtering of and QoS application to the predetermined flow;
a direct memory access configured to accumulate the flow information collected by the process array; and
a slow path processor configured to classify the flow information accumulated in the direct memory access into the flow information not requesting filtering and the flow information requesting filtering, store the flow information not requesting filtering and the flow information requesting filtering, and transmit each of the flow information not requesting filtering and the flow information requesting filtering to the system supervisor controller.

3. The flow-based QoS router capable of reporting real-time statistics of claim 2, wherein the slow path processor includes,
a statistics report server configured to classify the accumulated flow information into the flow information not requesting filtering and the flow information requesting filtering;
a statistics collection table configured to arrange the flow information not requesting filtering for each source address, each destination address, each source address & destination address and each application ID and store the arranged flow information in a statistics data format, and transmit the flow information not requesting filtering to the system supervisor controller every predetermined time; and
a filtering table configured to store the flow information requesting filtering in a raw data format and transmit the flow information requesting filtering to the system supervisor controller in real time.

4. The flow-based QoS router capable of reporting real-time statistics of claim 3, wherein the statistics collection table includes,
a source address aggregation table configured to store the flow information not requesting filtering for each source address;
a destination address aggregation table configured to store the flow information not requesting filtering for each destination address;
a source address & destination address aggregation table configured to store the flow information not requesting filtering for each source address & destination address; and
an application ID aggregation table configured to store the flow information not requesting filtering for each application ID.

5. The flow-based QoS router capable of reporting real-time statistics of claim 3, wherein the system supervisor controller includes,
a memory DB configured to arrange the flow information not requesting filtering in the order of count and byte to generate and store top N information and arrange the flow information requesting filtering for each source address, each destination address, each source address & destination address and each application ID to generate and store statistics information;
a DB interface configured to transfer the flow information not requesting filtering and the flow information requesting filtering received from each of the statistics collection table and the filtering table to the memory DB; and
a web server accessed by the manager terminal to monitor the top N information and the statistics information stored in the memory DB and perform filtering of and QoS application to the predetermined flow.

6. The flow-based QoS router capable of reporting real-time statistics of claim 5, wherein the manager terminal performs filtering of the predetermined flow simultaneously in the source address, the destination address, the source address & destination address.

7. The flow-based QoS router capable of reporting real-time statistics of claim 5, wherein the memory DB includes,
a flow raw record table configured to store the flow information requesting filtering;
a source address aggregation table configured to store the flow information requesting filtering by using the source address as a primary key or update the existing source address by analyzing the flow information requesting filtering;
a destination address aggregation table configured to store the flow information requesting filtering by using the destination address as a primary key or update the existing destination address by analyzing the flow information requesting filtering;
a source address & destination address aggregation table configured to store the flow information requesting filtering by using the source address & destination address as a primary key or update the existing source address & destination address by analyzing the flow information requesting filtering;
an application ID aggregation table configured to store the flow information requesting filtering by using the application ID as a primary key or update the existing application ID by analyzing the flow information requesting filtering;
a top N source address aggregation table configured to arrange and store the flow information not requesting filtering for each source address;
a top N destination address aggregation table configured to arrange and store the flow information not requesting filtering for each destination address;
a top N source address & destination address aggregation table configured to arrange and store the flow information not requesting filtering for each source address & destination address;
a top N application ID aggregation table configured to arrange and store the flow information not requesting filtering for each application ID;
a flow filter list table configured to manage a flow which a manager intends to filter; and
a switch information table configured to store switch information of the flow-based QoS router.
